(19) United States
(12) Patent Application Publication
(10) Pub. No.: US 2009/0007802 A1
(43) Pub. Date: Jan. 8, 2009

(54) Method and device for multi-purpose applications using interchangeable heads

(76) Inventor: Isaac Taitler, Haifa (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/824,331

(22) Filed: Jul. 2, 2007

(51) Int. Cl. A47J 43/00

(52) U.S. Cl. 99/453; 99/452; 15/4; 366/197

(57) ABSTRACT

A machine for automating manual labor has a portion to house the motor and at least three interchangeable head fittings for different applications. Applications include cleaning surfaces, cleaning vessels, mixer, blender, chopper, slicer, shredder, vibrator, massager, semi and fully automatic milk cream maker. The machine is driven by an electric motor that can perform different motions and actions, one at a time or simultaneously, depending on the head piece attached to the motor piece. Two such motions are rotary and linear. The machine is powered by battery or mains electricity.

### FIELD of the INVENTION

This invention is in the field of electrical motors and in particular a motor that causes a rotation and/or a linear reciprocating movement for use in a variety of applications as is detailed herein.

### BACKGROUND OF THE INVENTION

There are many kinds of electrical motors that perform a multitude of functions. There is a lack in known art of a compact hand-held electrical motor that can either rotate or reciprocate (that is oscillate) according to the choice of head attachment. Such a machine could have a multitude of functions by simply exchanging the operating head. For 15 example, such a machine could be used to clean utensils, be used as a vibrator, be used as a mixer, blender or chopper, and make whipped milk.

One application of the offered invention relates to a “plug and clean” apparatus for cleaning various kitchen utensils 20 which can not be properly cleaned neither manually nor in conventional dish washer and require additional cleaning by mechanical means.

There are known devices in the art which enable mechanical cleaning of utensils for example pot washer as per U.S. Pat. No. 5,450,646 to McHugh. In this apparatus there is arranged an electrically rotating brush. However this apparatus is unsuitable to clean narrow or small places which can be difficult to each like a pot's handle or a pan's handle and the like. The reason for this is that the known pot washers enable only rotation movement of the brush attachment. The construction of this washer is designed in such a manner that only a brush attachment of a certain kind can be used therewith.

The object of the present invention is to overcome or at least reduce the shortcoming of prior art cleaning devices. In the particular the main object of the present invention is to provide a cleaning device which can be used to rub, polish, brush kitchen utensils that known dish washer or pot washer cannot.

The “plug and clean” apparatus in accordance with the present invention is suitable for easy use and enables fast cleaning, time and expenses savings (hot water, powder 15 soap).

### SUMMARY of the INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but the not to limit the 5 invention to these descriptions only.

One of the invention's purposes is to offer an apparatus for effectively cleaning kitchen utensils by virtue of rotary movement or linear sliding movement of the cleaning heads.

A second purpose is to obtain efficient cleaning by a simple compact and cheap apparatus.

Third purpose is to allow fast and simple replacement of cleaning heads depending on necessary task i.e. either for rotary motion or linear reciprocating motion.

The invention enables in addition to the head movement 15 effected by a motor to apply also manual movement and thus to increase the efficiency of cleaning either in dry brushing or wet cleaning of soaped utensils.

Ready interchangeable means attached directly to rotary disk or reciprocating surface of the head can be made of different materials like “Scotch”™ or others.

The cleaning apparatus in accordance with the present invention can be operated without electric power, for example, cleaning unreachable corners, pan's or pot's handles or a narrow space in kitchen appliances. Its length and shape fits these needs. The apparatus can be used to scrape whitewash or paint signs from pavements, walls or other home utensils. The apparatus is compact, it does not require much space and is economical in cost to manufacture and operate.

Another application of the present invention relates to the preparing of whipped milk. The present well known method of processing milk foam is based on the heating of the milk using hot steam—this process is controlled manually and the quality of the milk foam is very much affected by the proficiency of the user (coffee maker in most cases). This process requires a specific combination of adequate heating 10 process and specialized usage of the steam.

The new proposed process will allow a high quality of milk foam making, even manually in a very simple procedure and a comparable consumption of energy.

The Milk Whipped System will implement the new process 15 in a very efficient and fast way, allowing all the mentioned advantages with the convenience of an automatic comprehensive process which will provide the user a high quality of milk cream on a “one finger touch” by a full automated process.

An additional application of the present invention is for kitchen use (mixer, blender, chopper . . . ). A Portable Kitchen Utensils for preparing food for a low price. An additional interchangeable head equipped with a rotary blade or with a rotary disk, will allow slicing or shredding or chopping\mixing.

A further application could be a vibrator that is based on a reciprocating and rotating movement.

An object of this invention is to change the motion of the machine of this invention by exchanging the head portion.

Another object of this invention is to change the movement of the machine from circular to linear reciprocation by exchanging the head portion.

Another object of this invention is to have a motor powered hand-held machine to perform a multitude of functions.

Another object of this invention is that the machine be housed in apparatus that stands on a work surface.

Another object of this invention is to facilitate cleaning vessels.

Another object of this invention is to mix, blend and chop food.

Another object of this invention is make whipped milk or whipped cream.

The basic two functions of the machine of this invention are to cause a rotary function and reciprocating (an oscillating) function. One of the innovations of the machine is to change 20 from rotary movement to reciprocating movement by changing the functionary head portion. The motor causes a turning movement in all applications and functions. The nature of the mechanism in the operating head causes the movement of the operating head to rotate or reciprocate or reciprocate while rotating.

There are two embodiments for the rotary movements and two embodiments for reciprocating movements and one embodiment for reciprocating movement while rotating.

In another embodiment of this invention milk can be turned into whipped milk or whipped cream. There is a semi-automatic embodiment and an automatic embodiment. The semi-automatic embodiment uses a whipping head attached to the motor and a linear movement while rotating is created. At a stage in the process the milk is heated which is effected manually and externally from the machine of this invention. The automatic embodiment is a free standing machine with a program and microprocessor, a heating element and temperature sensors in addition to the basic machine of this invention. This embodiment produces the end product by whipping and heating and further whipping of the milk according to series of actions controlled by the said program. This series of actions could be automatic upon switching on the machine.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 shows cleaning apparatus with the main portion and a replaceable cleaning head in accordance with one the preferred embodiments.

FIG. 2 shows the main portion of the apparatus together with the transmission means.

FIGS. 3a and 3b show respectively the main portion with mounted thereon cleaning head in its forward most and rearmost position.

FIG. 4 shows exploded view of the cleaning apparatus with the main portion and rotary replaceable cleaning head in accordance with the second embodiment.

FIG. 5 shows the cleaning apparatus equipped with the rotary 20 cleaning head.

FIGS. 6a and 6b show respectively an enlarged view in cross section of a portion of the apparatus shown in FIG. 5.

FIGS. 7a-7c show another embodiment of this invention where the oscillation motion is caused by a two-way 25 threaded screw and the rotating movement is achieved by a screw connection to the motor shaft.

FIG. 8 shows an enlarged view of the two-way threaded screw.

FIG. 9 shows an application as a vibrator.

FIG. 10 shows an application as a hand held semi-automatic whipped milk maker.

FIG. 11 shows an application as an automatic whipped milk maker.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

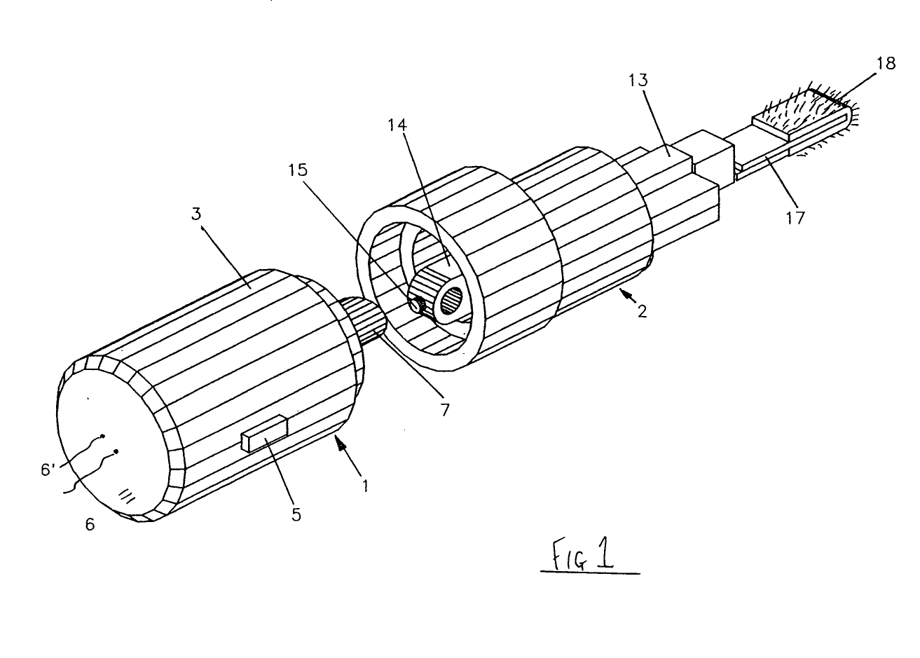

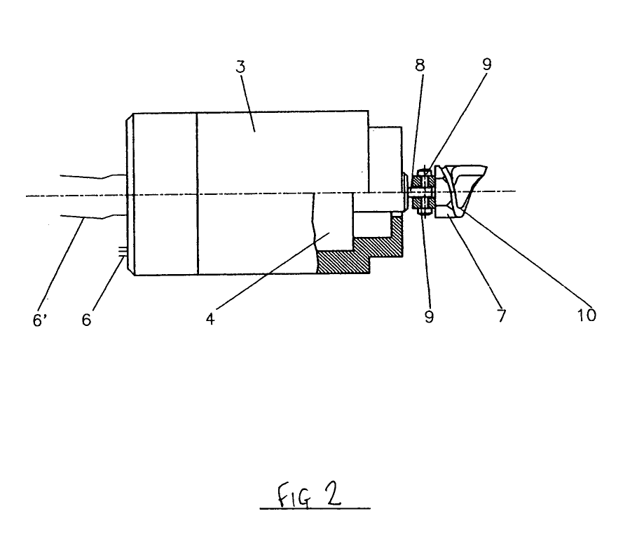

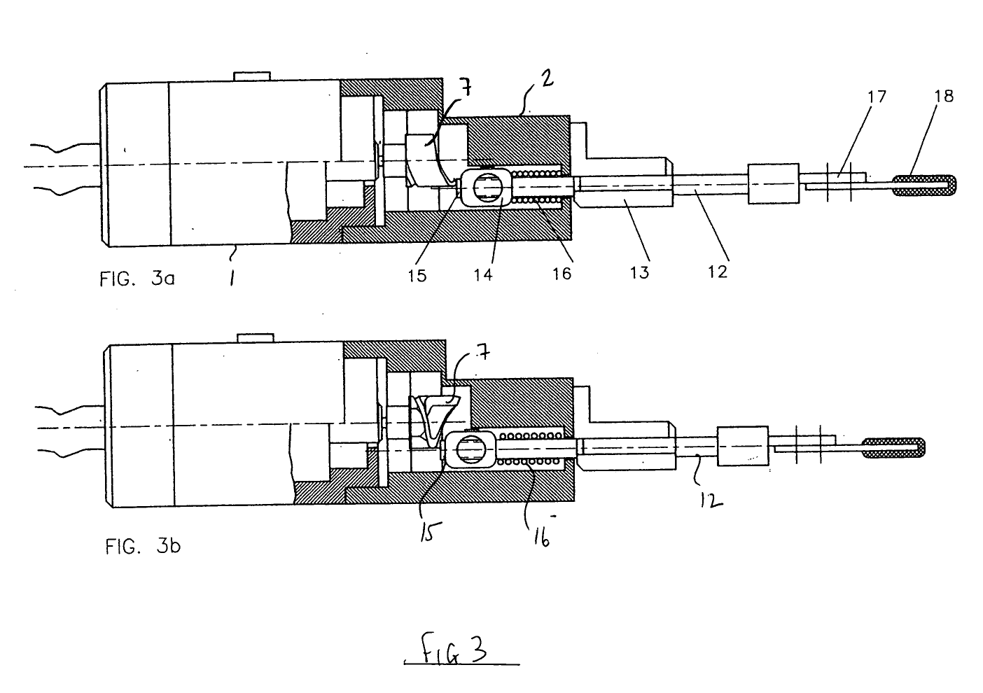

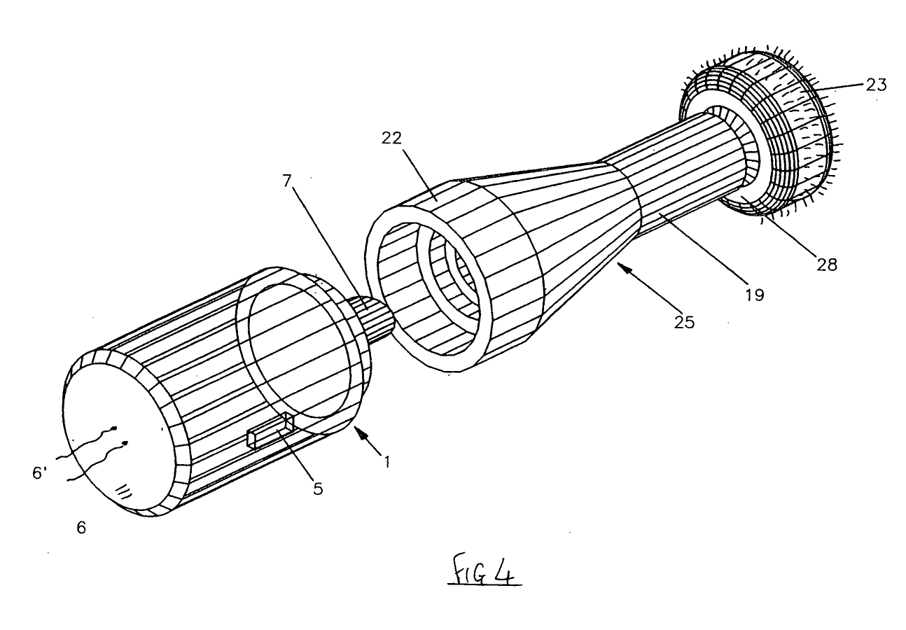

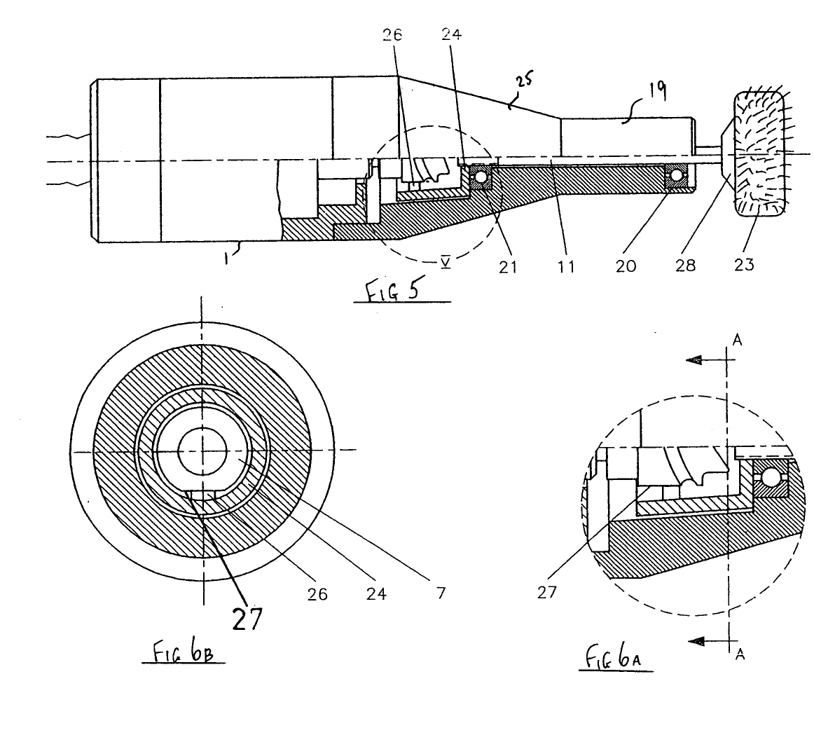

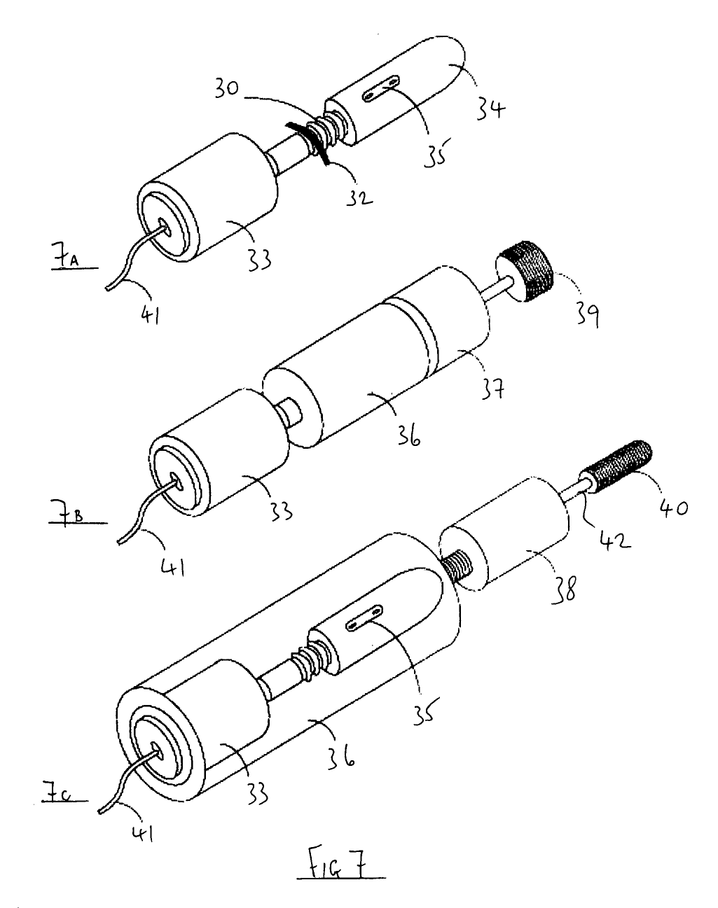

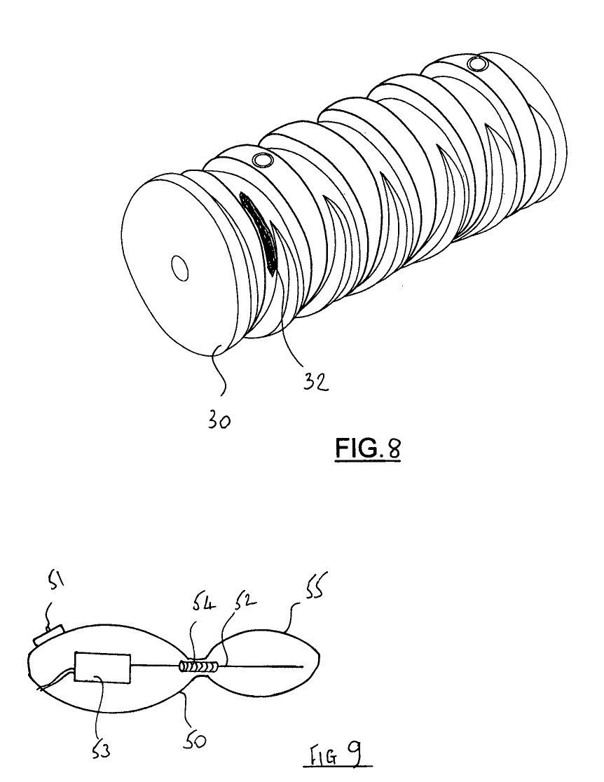

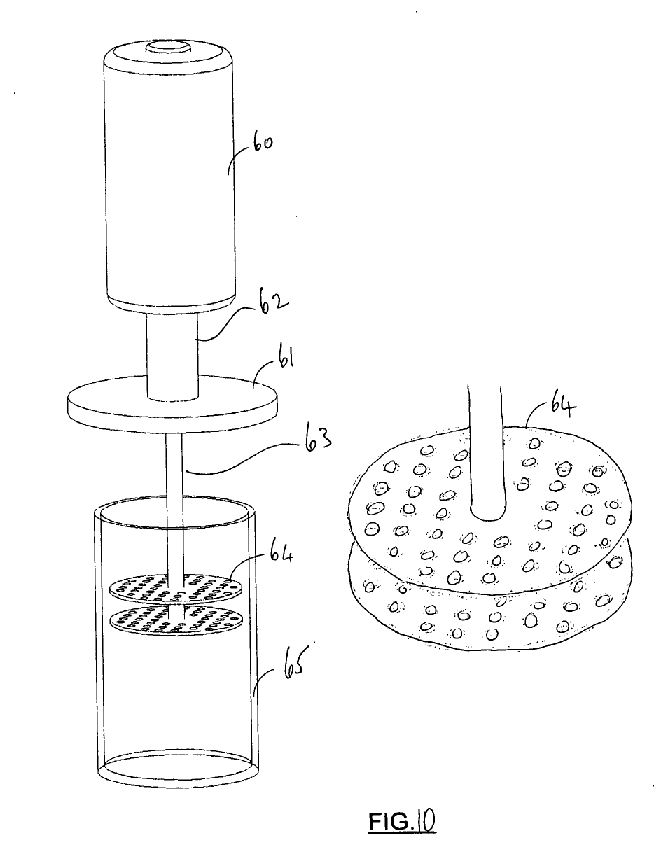

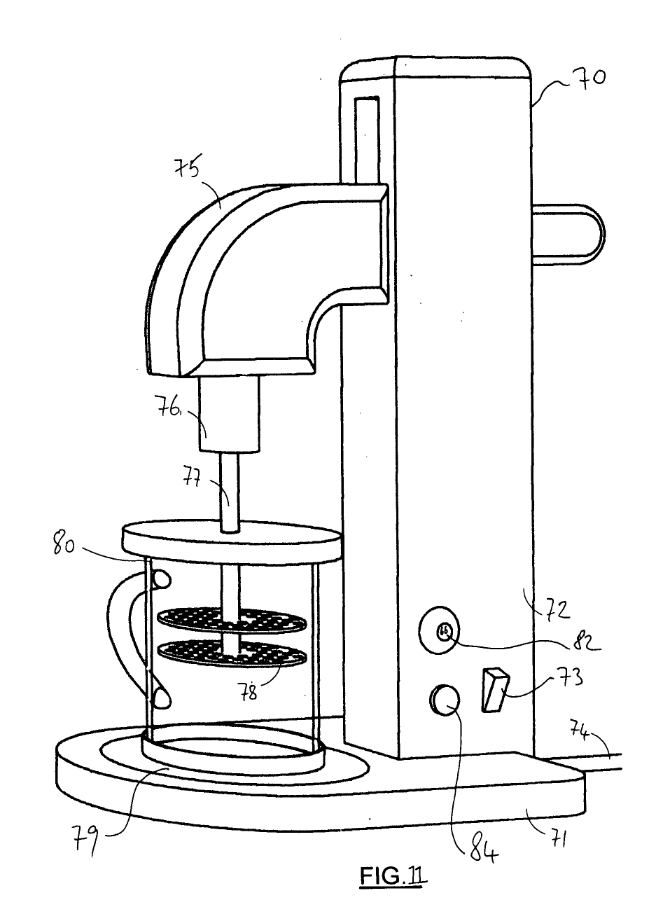

FIG. 1 shows a cleaning apparatus suitable for example, for cleaning a baking pan. The apparatus according to the first embodiment of the invention includes a main portion 1 and an interchangeable head 2 with a reciprocating (oscillating) shaft FIG. 3 12. Main portion 1 consists of a housing 3 and a motor FIG. 2 4 mounted therein.

The motor residing in housing 3 is operated from an internal source or an external one. An on/off knob 5 is supplied for controlling electrical power to the motor FIG. 2 4.

FIG. 2 shows the motor and transmission parts. For convenience cordless rechargeable battery could be used and in this case the apparatus could be equipped with appropriate plug 6 or it can be provided with a cord 6′ connected to a storage wall mounted unit. The transmission means 7 is connected to motor's shaft 8 via screws 9 and 9′. Rotational motion of the shaft effected by a motor is transferred to spiral surface 10 of the transmission.

The spiral surface 10 cooperates with pin 15 (FIG. 3) of the sliding shaft 12 of the head and causes a reciprocating (oscillating) motion thereto.

FIGS. 3a and 3b show the main portion 1 with the interchangeable head 2 with oscillating shaft 12 connected for lateral insertion and retention.

FIG. 3a shows the position of the shaft 12 as it is pushed to its extremity in a forward direction the pin 15 being pushed by the spiral transmission 7 as the transmission 7 turns. In this position the spring 16 is compressed.

FIG. 3b shows the position of the shaft 12 is in its extreme back position as the spiral transmission 7 continues to turn and the pin 15 is no longer pushed by the transmission 7. The spring 165 is free to expand and push the pin 15 and shaft 12 to a rear most position. As the transmission 7 continues to turn, the above movement is repeated many times a minute thereby creating the reciprocating effect to shaft 12 and all that is attached thereto.

Interchangeable head 2 includes in its forward part a sleeve portion FIG. 1 13 in which sliding shaft reciprocates. The forward end of the shaft FIG. 3 12 carries the sliding head FIG. 1 18.

A sliding shaft is provided with adjusting means FIG. 1 14 having a pin FIG. 1 15 at its rear end. The shaft slides within the head 2.

The reciprocating motion thereof can be adjusted via pin 15. Transmission 7 could be made of hardened steel and is used for coupling motor's shaft to both interchangeable heads and for submitting to them either the reciprocating linear motion or rotating motion.

The transmission 7 can push the sliding shaft 12 forward and backward within the sleeve against a retaining spring 16 bearing against a stop in head's housing.

The forward most portion FIG. 1 17 of cleaning head 2 is coated partially with rough pad 18 which cleans a desired surface.

The connection of the main portion 1 with interchangeable 20 head 2 causes the pin 15 to touch coupling's spiral surface 10, so translating rotary movement to linear sliding. The linear reciprocating sliding displacement is caused due to retaining spring 16 which forces sliding shaft 12 back.

FIG. 3a shows the sliding shaft at its forward position and FIG. 3b at its backward position according to previous description.

The given description leads to the understanding that adjusting means 14 attached to the sliding shaft 12 can be adjusted via a screw in order to establish the sliding amplitude of the forward part of sliding shaft equipped with rough pad 18.

FIGS. 4-6 show the cleaning apparatus according to the second embodiment implementing rotary movement of the interchangeable head.

FIG. 4 show interchangeable head 25 with rotary shaft FIG. 5 11 mounted within the head. Disk 28 is mounted on the forward cylindrical portion 19 of the head, which can rotate together with the rotary shaft FIG. 5 11. The shaft is mounted by virtue of two ball bearing FIG. 5 20 and 21 within the head and it goes there through from the rear-most portion FIG. 4 22 of the cleaning head to the forward most portion thereof.

Disposable cleaning roughened attachments 23 is adhered to the disk.

FIG. 5 shows the main portion 1 with coupled thereto interchangeable head 25 carrying rotating shaft 11.

The rotating shaft 11 is centrally mounted with respect to longitudinal axis of the head 25 by virtue of an internal driven cup FIG. 6b 24 and bearings 20 and 21. When coupled to the main portion the cup is rotated by the transmission 7, it in turn rotates the rotating shaft 11. Seeing that the rear-most portion of the shaft 11 is provided with a thread, the cup 24 can be fixed thereon and thus rotation can be transferred from the cup 24 to the shaft 11. The inwardly facing cylindrical surface of the cup 24 is provided with a torque transmission pin FIG. 6b 26, directed radially respect thereto. The transmission 26 is provided with a plane FIG. 6a 27 for transmitting torque. By virtue of interaction between the pin 26 and plane FIG. 6a 27, rotation is transmitted from the transmission means to the shaft.

FIGS. 6a and 6b show a sectional view of the transmission 7 cooperating with a plane 27 for transmitting torque via pin 26 to the driven cup 24 which in turn transmits torque to rotary shaft FIG. 5 11 ended with a working disk FIG. 5 28. The outside part of the working disk is covered with a disposable cleaning attachment FIG. 5 23 having rough surface.

Above description emphasizes that to main portion 1 can be attached various working heads either for linear or rotary motion-causing a significant improvement to for example cleaning work.

By virtue of the above design the apparatus is efficient, compact, easy in use and cheap. Disposable working 20 attachment pads like “scotch” can be attached to rough surface via glued paper on its back or held with Velcro fitted both to working heads and cleaning device.

This arrangement causes fast and easy replacement of worn working pads for effective cleaning work.

FIG. 7 shows the transmission components connected to the motor's shaft.

The transmission means are based on a left and right screw component 30 of predetermined width and length according to the reciprocating amplitude and mechanical moment on the motor's shaft. A leaf or rider 32 is located on the screw 30 (that is fastened to the motor 33 between the screw 30 and the cylindrical transmission 34 causing the transformation of rotary motion of the motor's shaft to linear reciprocating motion of the cylindrical transmission. The reciprocating movement happens when the cylindrical transmission 34 is prevented from rotating while moving along a predetermined path inside the housing 36. In order to achieve the reciprocating movement, the cylindrical transmission 34 is directed within the housing by a length of protrusion 35 that reciprocates within the inner part of the housing 36 while preventing the rotary motion of the cylindrical transmission 34. The protrusion 35 sits in a matching groove on the inside of housing 36.

The leaf or rider 32 could move from one end (start point) of the screw 30 to the opposite end (end point). The leaf or rider's 32 change of direction is caused by the inverting 20 direction (from left handed to right handed screw or from right ended to left handed screw at the opposite side), so causing the oscillating motion of the cylinder transmission 34 moving inside the housing 36.

The rotating and reciprocating heads are seen in pictures 7b and 7c respectively.

In FIG. 7b, a rotating head 37 contains the rotating shaft that is connected to a screw that causes the rotary motion of the shaft. Velcro material could cover the end 39 of the working rotating shaft.

In FIG. 7c, the oscillating head 38 contains the oscillating shaft. Velcro material could cover the end 40 of the working reciprocating shaft.

The working reciprocating shaft FIG. 7c 42 is attached to the cylinder transmission that causes the reciprocating movement of that shaft. Hence the amplitude of the reciprocating shaft depends on the screw's 30 length.

Attaching simultaneously two shafts, one to the screw 30 and the second to the cylindrical transmission causes simultaneously rotating and oscillating movements of the shafts. The electrical cord 41 could be attached to a battery source or to an isolated transformer connected to line.

FIG. 8 shows an enlarged view of the two way screw 30. The leaf or rider 32 rides on one side of the double threaded screw. The motor turns the shaft and the shaft turns the screw 30. When the leaf or rider 32 reaches the end of the thread of screw 30, the leaf or rider 32 automatically moves 20 to the other threaded side. Even though the motor turns the shaft in the same direction, the leaf or rider 32 reciprocates back and forth each time the leaf or rider 32 reaches the end of the thread of screw 30. The leaf or rider 32 is attached to the cylindrical transmission FIG. 7a and thereby 25 the reciprocating motion is transferred to the head that is desired to reciprocate.

FIG. 9 shows the application of this invention as a massage device 50 or vibrator where the user could choose to operate the rotation motion or the linear oscillating motion or both motions at the same time. The different effects could be operated using the switch 51. The rotation motion could be turned into a vibration by the connection between the motor shaft and the applicator 55 to be off center 52 in the applicator. The motor 53 provides the rotational force. The housing of the motor 53 would also act as the handle for the device. The double screw 54 would turn the rotational force 10 of the motor 53 into a linear back and forth reciprocating motion as described in relation to the embodiments in FIG. 7. The applicator 55 could be made for example, hard and smooth or somewhat flexible material as is necessary to provide the desired effect for the user.

FIG. 10 shows the application of this invention as a semi-automatic hand-held milk whipping machine. The mechanical operation of this embodiment is as described in FIG. 7 where the device produces a reciprocating motion. The motor is housed in the handle 60. A splash protecting disc 61 prevents milk splashing onto the handle 60 or outside container 65. The double threaded screw could be housed in section 62. At the distal end of the shaft 63 is at least one plate 64 with many holes therein. The sectional shape of container 65 would preferably be like the shape of the holed plate 64 and a little larger in size to facilitate the plate 64 moving up and down in the container 65.

When the motor is switched on the holed plate 64 would moving up and down in pre-heated milk and that motion would create whipped milk. There could also be a rotational motion in addition to the reciprocating motion.

The milk could be heated again to produce a higher quality 5 milk foam product.

FIG. 11 shows a table top automatic whipping milk or whipping cream machine 70. The base 71 could be heavy or fixed to the surface used. The electrical components and control unit could be housed in the hollow of the stand 72.

The operation switch 73 would be the on/off control. The power could be provided from an A/C power source via cable 74. The motor could be housed in motor housing 75. The double screw could be in the screw housing 76 causing the shaft 77 to move up and down. The shaft 77 could also spin on its own axis.

At the distal end of the shaft 77 are the perforated plates 78 that help to produce the whipped milk or cream when moved up and down in milk. The container 80 could be slightly larger in diameter than the plates 78 so that milk would not escape easily between the plates 78 and the inside edge of the container 80. The container could have as its base an electrical heater 79 to heat the milk at the required stages in the whip making process. There could be a thermostat connection between the milk and the control unit. The temperature reading could be shown on a display 82. The timing of the heating process and the whipping process could be controlled and operated from the control unit operating panel 84.

What is claimed:

1. A method and device for achieving rotary and linear motion comprising,
a. a motor powered by electricity,
b. a means of transmission of rotational force of said motor by means of a partially complete spiral, concentric with the said motor drive axle,
c. a head-piece, one end of which attaches to the said motor housing and at the distal end of the said head-piece is a functionary portion,
d. an axle positioned longitudinally in the said head-piece with a pin riding on said spiral and at the distal end of the said axle a connection to the said functionary portion, and
e. a spring to push the said axle and head-piece 20 back towards the said motor when the spiral turns passed the extreme forward position of the said spiral,
whereby the said rotary force of the said motor is transmitted to a linear force in the said axle 25 moving the said head-piece back and forth reciprocately as the said spiral revolves.

2. A method and device for achieving rotary and linear motion as claimed in claim 1 wherein the said functionary portion is adapted and applied to one or more of the following; cleaning vessels, cleaning surfaces, chopping objects, slicing objects, mixing 5 objects, massaging, vibrating, whipping milk, whipping other liquids.

3. A method and device for achieving rotary and linear motion as claimed in claim 1 wherein the said head piece comprises a bar across its diameter at the end 10 closest to the said motor whereby the said spiral catches on the said bar and causes the said head-piece to rotate as the said spiral rotates.

4. A method and device for achieving rotary and linear motion as claimed in claim 1 wherein the said linear motion is created by means of a two way threaded screw with a rider in the thread grove attached to the said head-piece housing.

5. A method and device for achieving rotary and linear motion as claimed in claim 1 wherein the rotary 20 motion is achieved by a screw and thread connection between the rotating motor side and the said head-piece side.

6. A method and device for making whipped liquid comprising,
a. a motor powered by electricity,
b. a means of transmission of rotational force of said motor by means of a partially complete spiral concentric with the said motor drive axle,
c. a head-piece, one end of which attaches to the said motor housing and at the distal end of the said head-piece is at least one disc perforated with holes,
d. an axle positioned longitudinally in the said head-piece with a pin at the said spiral end of the said axle and at the distal end of the said axle a connection to the said perforated discs, and
e. a spring to push the said axle and head-piece back towards the said motor after the said spiral has pushed the said axle away from the said motor,
whereby the said rotary force of the said motor is transmitted to a linear force in the said axle moving the said axle and hence the said perforated discs back and forth as the said spiral revolves and thereby whipping the said liquid.

7. A method and device for making whipped liquid as claimed in claim 6 wherein the said linear motion is created by means of a two way threaded screw with a rider in the thread grove attached to the said head-piece housing.

8. A method and device for making whipped liquid as claimed in claim 6 further comprising,
a. an electronic control unit to control the elements, functions and sequence of actions of this embodiment,
b. a means to measure the temperature of the said liquid where the said measurement is communicated to the said control unit,
c. a means to heat the said liquid where the control of the said heat is connected to the said control unit.
whereby liquid can be heated to a pre-set temperature, whipped by the movement of the said perforated plates and where necessary re-heated to a pre-set temperature.

9. A method and device for making whipped liquid as claimed in claim 6 wherein the said linear motion is created by means of a two way threaded screw with a rider in the thread grove attached to the said head-piece housing.

10. A method and device for making whipped liquid as claimed in claim 6 wherein a rotary motion is created.

11. A method and device for making whipped liquid as claimed in claim 8 wherein the said linear motion is created by means of a two way threaded screw with a rider in the thread grove attached to the said head-piece housing.

12. A method and device for a making whipped liquid as claimed in claims 6 and 8 further comprising a means for the said rotary motion and the said linear motion to operate simultaneously.

13. A method and device for a vibrator comprising,
a. a motor powered by electricity,
b. a means of transmission of rotational force of said motor by means of attachment concentrically with the said motor drive axle,
c. linear motion created by means of a two way threaded screw with a rider in the thread grove attached to the head-piece housing,
d. a head-piece, one end of which attaches to the said motor housing and at the distal end of the said head-piece is a massage head,
e. an axle positioned longitudinally in the said head-piece with a pin riding on said spiral and at the distal end of the said axle a connection to the said massage head, and
f. a spring to push the said axle and head-piece back towards the said motor when the spiral turns passed the extreme forward position of the said spiral,
whereby the said rotary force of the said motor is transmitted to a linear force in the said axle moving the said head-piece back and forth reciprocately as the said spiral revolves and thereby creating a vibratory effect.

14. A method and device for a vibrator as claimed in claim 13 further comprising a means for the said rotary motion and the said linear motion to operate simultaneously.

15. A method and device for a vibrator as claimed in claim 13 further comprising a means for the said rotary motion and the said linear motion to operate simultaneously.

16. A method and device for a vibrator as claimed in claim 13 further comprising a means for the said rotary motion and the said linear motion to operate simultaneously.

17. A method and device for achieving rotary and linear motion as claimed in claim 1 further comprising a means of adjusting the amplitude of the said linear motion.

18. A method and device for making whipped liquid as claimed in claim 6 further comprising a means of adjusting the amplitude of the said linear motion.

19. A method and device for a vibrator as claimed in claim 13 further comprising a means of adjusting the amplitude of the said linear motion.

20. A method and device for achieving rotary and linear motion comprising,
a. a motor powered by electricity,
b. a head-piece, one end of which attaches to the said motor housing and at the distal end of the said head-piece is a functionary portion,
c. a means of transmission of rotational force of said motor to the said head-piece by means of by a screw and thread connection between the rotating motor end and the said head-piece end,
d. a means of transmission of rotational force of said motor into linear motion by means of a two way threaded screw with a rider in the thread groove attached to the said head-piece housing,
whereby the said rotary force of the said motor is transmitted to a linear force in the said axle moving the said head-piece back and forth reciprocately as the said two way threaded screw revolves and whereby the said rotary force of the said motor is transmitted to a linear force and a rotary force simultaneously.
